(19) United States
(12) Patent Application Publication
(10) Pub. No.: US 2011/0120381 A1
(43) Pub. Date: May 26, 2011

(54) PREPARATION OF FEED COMPOSITIONS

(75) Inventor: Morten Aga, Vaksdal (NO)

(73) Assignee: SEAFARM PRODUCTS AS, Vaksdal (NO)

(21) Appl. No.: 12/922,096

(22) PCT Filed: Mar. 10, 2009
(86) PCT No.: PCT/GB2009/000643

§ 371 Date: Dec. 6, 2010

(30) Foreign Application Priority Data
Mar. 10, 2008 (NO) 20081242

(51) Int. Cl. A01K 61/00; A23K 1/18

(52) U.S. Cl. 119/200; 426/560

(57) ABSTRACT

The invention provides a method of producing an aquaculture feed composition which method comprises causing water, optionally together with a lipid, to be taken up by protein-containing feed pellets, characterised in that said pellets contain as a binder a plant seed flour.

This invention relates to the preparation and use of feed compositions for aquacultural use.

In aquaculture, the cultured species, usually fish or shellfish, is normally fed with pellets containing the protein and lipid necessary for animal growth and survival. The feed pellets have to be produced, usually by extrusion, packaged and transported to the farmer before being fed to the cultured species. Such handling places the requirements that the pellets be durable and compact. Accordingly, even though aquatic species have little need of carbohydrate in their feed, aquaculture feed pellets routinely include starch or a starch-containing material, such as crushed (e.g. gritty, hammer-milled) plant seed, as a binder. If finely ground seed, i.e. flour, were to be used as a binder for feed pellets, the resulting pellets would be hard and compact. This is not problematic for feeds for land animals or birds, as they have strong jaws or beaks, but for fish feeds it is normal instead to use crushed seeds to avoid this result.

Feeding fish is unlike feeding land-based animals or birds. With the feed, marine fish also ingest salt-water and to maintain their ionic balance it is important that the feed pellets should contain water at lower salinity than sea water. Where feed pellets are hard, the fish will generally have to consume ambient water to ensure that the pellets soften and disintegrate sufficiently after ingestion—thus it is important that feed pellets be relatively soft before administration. This of course is in contradiction to the requirement for compactness and durability up to delivery to the farmer.

A further problem with hard compacted feed pellets is of course that they may sink through the base of any aquaculture holding cage and so be wasted. Moreover hard compact pellets may suffer from non-uniform water uptake on administration—the pellets become soft on the outside while remaining hard within. This may cause the fish to have to consume more salt water or may also contribute to waste as mentioned above.

Aquaculture in cold regions causes further problems particular to fish feed. The ambient temperature at which the feed pellets are stored may be below the freezing temperature of the water in the holding cages—placing cold feed pellets in the water may cause an ice layer to form around the pellets so reducing their efficacy in several ways. Thus iced-over hard pellets may be swallowed whole and excreted without being digested.

One response to these problems of aquaculture feed pellets has been to load the pellets with water, at the aquaculture operation site. This is described for example in WO02/28199 in which the pellets are placed in water, subjected to an underpressure to remove trapped air and then subjected to an overpressure to drive as much water as possible into the pellets which can then be administered.

We have now surprisingly found that when this technique is applied to aquaculture feed pellets in which seed flour has been used as the binder, the ability of the pellet to soften and swell, i.e. to absorb fresh water so reducing the ionic balance problems for the fish, is significantly increased, e.g. by a factor of about 5 as compared with the use of crushed seed. Thus, by way of contrast, feed pellets made using 15% wt sieved wheat flour and using 15% wt crushed wheat showed water uptake values of 0.3 and 1.6 L/kg respectively. While it is known that, at high temperatures, e.g. above 50° C., powdered starches have increased ability to absorb water, it should be noted that this swelling is now observed at ambient temperature (which may be below 0° C.). Thus rather than being an undesired disadvantage, the use of seed flours has surprisingly been found to be an advantage.

Viewed from one aspect therefore the invention provides a method of feeding farmed aquatic animals (especially fish and shellfish, and particularly marine animals, especially animals in nets, tanks or cages), which method comprises administering into the water in which said animals are kept protein- and lipid-containing feed pellets which have been caused to soak up water, characterised in that said pellets contain as a binder a plant seed flour.

Viewed from a further aspect the invention provides a method of producing an aquaculture feed composition which method comprises causing water, optionally together with a lipid, to be taken up by protein-containing feed pellets, characterised in that said pellets contain as a binder a plant seed flour.

The pellets in the composition of the invention are water-swellable, preferably having a (fresh) water uptake before disintegration of at least 0.1 L/kg, more preferably 1 to 7, especially 1 to 4, particularly 1 to 2, more particularly 1.2 to 1.8, e.g. about 1.5, L/kg.

The pellets may, if desired, be free of any therapeutic agent, e.g. pharmaceuticals such as antibiotics and oral vaccines.

The pellets will conveniently contain protein and lipid at contents substantially similar to conventional aquaculture feed pellets. Thus, on a dry weight basis, the pellets will typically contain 40 to 80% wt, especially 50 to 75% wt protein and 5 to 40% wt lipid, especially 6 to 35% wt, lipid (e.g. fish oil).

The pellets of and used according to the invention will generally be prepared by extrusion and this forming process may chemically and structurally modify the pellet ingredients. Thus by a pellet containing a seed flour is also meant a pellet formed using seed flour as an ingredient.

The water-uptake step in the method of the invention may simply involve steeping the pellets in water, preferably fresh (as opposed to salt) water. However, it is especially preferred to immerse the pellets, apply an under-pressure and then apply an overpressure. In this regard reference may be had to WO02/28199 the contents of which are hereby incorporated by reference.

While the feed pellets may already be loaded with lipid before the water uptake step, lipid may if desired be loaded simultaneously with water, e.g. using an aqueous lipid emulsion or gel. In this regard, reference may be had to WO2006/098629 the contents of which are also incorporated by reference.

The feed pellets may be tailored to the needs of the animals being fed by addition of additives such as colorants, oral vaccines, medicines, and the like following delivery to the farmer. Such addition, which may for example be of the substances dissolved or dispersed in water or lipid, may take place when the feed pellets are loaded with lipid, with lipid and water, or with water. In this way, a small number of “standard” unloaded feeds may be sufficient, perhaps ones tailored to selected fish species, allowing the farmer herself to modify a standard feed to produce one suited to the season or the developmental stage or species of her fish. In this way, feed pricing and efficiency of use can be optimised.

Thus, in a preferred embodiment of the methods of the invention, the pellets are impregnated with additives selected from the group consisting of colorants, vitamins, minerals, medicines and oral vaccines at the point of use, i.e. by the farmer at or adjacent the enclosure containing the aquatic animals.

The lipid used may be any plant, microbial or marine oil or other lipid capable of serving as a nutrient for the cultural species. In general a mixture of plant and marine oils will be preferred.

The protein in the pellets will again be any protein or protein-containing material capable of serving as a nutrient for the cultured species. In general, a fish meal or land-animal-waste meal will be used. Plant protein may also be used, generally as a minor proportion of the overall protein content.

Pellet formation may be effected by standard techniques, for example extrusion of a heated water-containing mixture of the pellet ingredients. This may be done in conventional fashion using conventional equipment and the resulting pellets will generally be dried and packaged for storage and distribution.

The plant seed flour may be the flour, i.e. the pulverulent product of grinding, of any edible dry plant seed, preferably pulses (e.g. pea or lentil) or a cereal plant, for example corn, oat, rice, wheat, barley or rye, and most preferably wheat. The husk of the seed is preferably removed, e.g. by sifting, since, as discussed above, fish need for carbohydrate is very limited. Particularly preferably the flour has a particle size in the region of 1 to 250 μm, especially 1 to 180 μm. Flour having a mode particle size of about 5 to 200 μm, especially 20 to 150 μm, particularly 25 to 100 μm is particularly preferred. Measured on Tyler mesh scale these particle size ranges can be equated roughly to 2500-70, 625-100 and 600-140. Mode particle size may be determined with a Coulter particle size meter.

The quantity of plant seed flour used is preferably 1 to 40% wt, especially 1 to 35% wt, particularly 5 to 15% especially about 15% wt of the total pellet weight (before water addition before administration). Alternatively, the quantity of plant seed flour used is preferably 1 to 35% wt, particularly 5 to 20% wt, especially 12 to 18% wt, relative to the total dry solid weight of the material to be pelleted. Where the lipid is included in the material to be pelleted, the percentage will be towards the lower ends of these ranges.

While some crushed seed may be used in the pellets of the invention, this is preferably a minor proportion, e.g. up to 5% wt, more preferably less than 2% wt, relative to the total dry weight.

The pellets will generally be extruded pellets; however they may also be made in whatever form desired by any appropriate method that includes compaction.

Besides lipid, protein and plant seed flour, the pellets may contain further optional ingredients such as are conventional in aquaculture feeds, e.g. further binders, gluten, vitamins, minerals, colorants (e.g. carotenoids such as astaxanthin), antioxidants, medicines (e.g. antibiotics), oral vaccines, etc. In a particularly preferred embodiment of the invention further such ingredients tailored to the needs of the farmer or the cultural species may advantageously be incorporated into the pellets after delivery and either before or at the same time as the water uptake.

Prior to water uptake, the pellets will desirably have a moisture content of 2-10% wt, especially 4-6% wt.

The pellets are preferably formed by extrusion using a low water content extrudate. This results in a particularly high density pellet and thus in economies of transport and storage. Nonetheless such high density pellets have the ability to absorb very high volumes of water. The pellets, before water uptake, are themselves new and form further aspects of the invention.

Thus viewed from one aspect the invention provides an aquaculture feed composition comprising protein-containing pellets'further containing as a binder a plant seed flour, said pellets having a pellet solids density of at least 380, preferably at least 400, especially at least 430, for example up to 650 g/L. By “pellet solids density” is meant the mass of solid material, i.e. material other than oils and water, contained in a unit volume of pellets. This may be estimated simply by summing the masses of components other than liquids used to produce a unit volume of pellets. Since the unit'volume (typically a litre or more) of pellets contains spacings between the pellets, the true solids density may be in excess of 1000 g/L.

Unlike conventional aquaculture feed pellets the pellets of the invention contain plant seed flour. However, unlike land animals, marine animals have a low need for carbohydrates and so the plant seed flour content is preferably relatively low. This can be expressed as a percentage of the dry weight (i.e. weight excluding moisture) of the total pellet weight with or without the lipid component, as the oil may be introduced on pellet formation or, more routinely, it may be added to pre-formed pellets.

Expressed as a percentage of pellet weight excluding oil and water (moisture), the plant seed flour preferably constitutes 1 to 25% wt of the pellets, particularly 5 to 23% wt, especially 10 to 20% wt, particularly 10 to 18% wt. This, may be estimated as the percentage of the weight of the pellet components other than the oil and water that is constituted by the plant seed flour.

Alternatively, expressed as a percentage of pellet weight including oil but excluding water, the plant seed flour preferably constitutes 1 to 18% wt of the pellets, particularly 5 to 17% wt, especially 10 to 16% wt. This may be estimated as the percentage of the weight of the pellet components other than water that is constituted by the plant seed flour.

Thus viewed from a further aspect the invention provides an aquaculture feed composition comprising protein-containing pellets further containing as a binder a plant seed flour, the plant seed flour content being 1 to 25% wt relative to the weight lipid and water or 1 to 18% wt relative to the weight of the other pellet components other than lipid and water, or 1 to 18% wt relative to the weight of the other pellet components other than water.

Viewed from a still further aspect the invention provides an aquaculture feed composition comprising protein-containing pellets further containing as a binder a plant seed flour said pellets having a fresh water-uptake capacity before disintegration of 0.8 to 7 L/kg, preferably 0.9 to 4 L/kg, especially 1 to 2 L/kg.

The invention will now be described with reference to the following non-limiting Examples and the accompanying drawing in which:

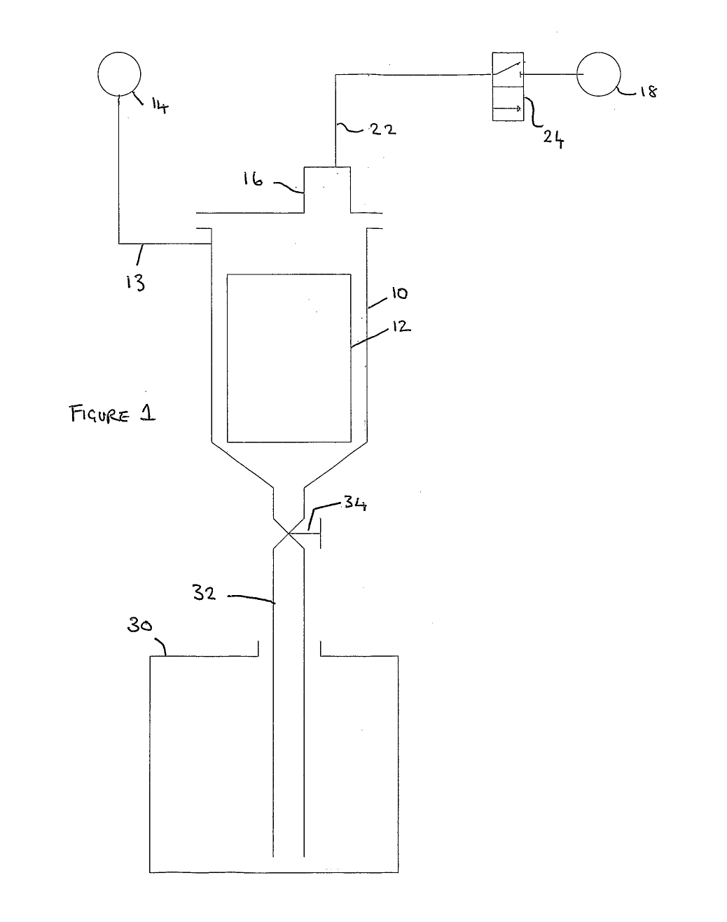

FIG. 1 is a schematic diagram of an apparatus for introducing water into aquaculture feed pellets.

Referring to FIG. 1, there is shown a vessel 10 (a vacuum tank) arranged to receive a feed container 12 (e.g. a perforated plate container). The vessel (10) is coupled from above via conduit 13 to a manometer 14 for the measurement of pressure within the container and the vessel. A cover 16 can close the vessel 10 so that it can be depressurized. A vacuum generator 18 is coupled to the interior of vessel 10 via conduit 22 and cover 16. A valve 24 can be switched between allowing conduit 22 (and so vessel 10) to be coupled to the vacuum generator for depressurization and allowing it to be coupled for inletting air, when the pressure will rise to normal (i.e. atmospheric) pressure.

The base of vessel 10 is coupled via conduit 32 (e.g. a plastics tube) to a fluids container 30 (generally a plastics tank) which can accommodate the fluid (e.g. water, optionally containing colorant) the feed pellets are to be filled with. Conduit 32 includes a valve 34 for admitting fluid into the vessel and container. Under evacuation, valve 34 is closed. When the desired vacuum (e.g. 95%) is reached it is opened and the fluid is drawn up by the vacuum and fills the vessel which has the feed container disposed inside it. When the feed particles have taken up the fluid, the fluid can be allowed to drain back into fluids container 30.

With reference to the FIGURE, an operation sequence might be as follows:

At start, all valves shut.
1. Place feed into feed container 12.
2. Place feed container 12 in vacuum vessel 10.
3. Seal cover 16 on vessel 10.
4. Start vacuum generator 18.
5. Open valve 24 to allow generator 18 to evacuate vessel 10.
6. When manometer 14 shows an about 95% vacuum, open valve 34 to fluids container 30.
7. When the water is sucked up into the vacuum vessel, close valve 24.
8. Reset valve 24 to allow air inflow.
9. Open the cover.
10. Open the water valve 34.
11. When all the water has drained off, take feed container 12 out of vessel 10.

These steps are only by way of example. The procedure may be effected in many ways.

### EXAMPLE 1

### Cod Feed

A dry mix of fish meal, sifted wheat flour (e.g. Hvetemel siktet) from Møllerens, Bergen, Norway, particle size up to 200 μm) and a vitamin and mineral mix in a 760:160:1 weight ratio is extruded (as in Example 3) under heat and pressure, mixed together with water (to 10% wt). The pellets are dried to a water content of about 5% wt whereafter fish oil is added to a content of 8% wt. The resultant pellets have protein, fat, carbohydrate and water contents of about 55.1% wt, 15.75% wt, 11% wt and 5% wt respectively. The pellets have a density of about 550 g/L before fish oil addition and about 600 g/L after fish oil addition. These densities are for pellets in bulk—if the spaces between the pellets are allowed for, the two densities adjust upwards to about 1020 and 1070 g/L.

### EXAMPLE 2

### Salmon Feed

Pellets are extruded as in Example 1 using a dry mix of fish meal, sifted wheat flour and a pigment, vitamin and mineral mix in a weight ratio of 600:160:1. The pellets are dried to a water content of about 5% wt whereafter fish oil is added to a content of 24% wt. The resultant pellets have protein, fat, carbohydrate and water contents of about 45.2% wt, 30.5% wt, 11% wt and 5% wt.

### EXAMPLE 3

### Pellet Extrusion

Pellets are extruded using a conventional feed pellet extruder but with lower than normal water addition. The conditioner temperature is 80° C., the dry mix feed rate 1000 kg/hr, the water addition rate 100 L/hr, the dryer temperature 80° C. (to dry the product to 5% wt water content), and the oil addition rate after drying 87 kg/hr.

The dry materials are mixed and placed into a feed silo to be transported to the extruder. The dry mix is preheated using steam in the conditioner and then transported to a Buhler extruder where further water is added, here to an overall water content of about 10% wt. (This reduces the amount of water to be removed in the dryer and results in a highly absorbent product). In the extruder, mechanical energy is added causing the extrudate to heat up. The mixture is extruded through a die and cut into pellets. The pellets are then dried in a dryer at 80° C. to a moisture content of about 5% wt. Fish oil or other lipid is then added in a vacuum coater whereafter the pellets are cooled and packaged for storage and transportation.

### EXAMPLE 4

### Water Addition

Pellets, for example those of Examples 1 and 2; may be water-impregnated using the technique of WO02/28199. Thus for example the procedure may be as follows:

i) the pellets are placed in a container,
ii) water (or other aqueous liquid), optionally containing additives the feed pellets should take up, is contacted with the container so as to fully cover the pellet mass for a period sufficient that the flour in the pellets takes up sufficient liquid, and
iii) the feed pellet mass is feed to the aquatic animals.

In step (ii) the container with pellets and liquid can be brought to a selected underpressure so as to draw air out of pores in the pellets. The underpressure can be released and atmospheric pressure or an overpressure may be applied so as to drive liquid into the pores of the pellets and so result in the stated uptake of sufficient liquid by the flour in the pellets.

More particularly the process involves:

a) a quantity of feed pellets is placed in a water-penetrable container,
b) the container is placed in a vessel,
c) the vessel is placed under an underpressure such that it is evacuated, particularly to an about 95% vacuum,
d) liquid, optionally containing useful materials, is fed to the vessel until the pressure is about level and the pellets have soaked up the liquid and useful materials,
e) the water is drained off and the container is optionally taken out of the pressure vessel, and
f) the feed pellets are led to the waterside for feeding to the aquatic animals, preferably using water as the transporting agent.

If desired the pellets can be loaded into the pressure vessel in a water penetrable cage. The procedure is described above in connection with the description of FIG. 1.

1. A method of feeding farmed aquatic animals, wherein said method comprises administering into water in which said animals are kept protein- and lipid-containing feed pellets which have been caused to soak up water, wherein said pellets contain as a binder a plant seed flour.

2. A method of producing an aquaculture feed composition, wherein said method comprises causing water, optionally together with a lipid, to be taken up by protein-containing feed pellets, wherein said pellets contain as a binder a plant seed flour.

3. The method as claimed in claim 2 wherein said pellets are configured to take up water by reducing a pressure to remove air from the pellets and by contacting the pellets with water or an aqueous liquid.

4. The method as claimed in claim 1 or 2, wherein said plant seed flour is a cereal or pulse flour.

5. The method as claimed in claim 4 wherein said plant seed flour is wheat flour.

6. The method as claimed in claim 4 wherein said plant seed flour is pea flour.

7. The method as claimed in claim 1 or 2, wherein said pellets have a pellet solids density before soaking up water of at least 380 g/L.

8. The method as claimed in claim 1 or 2, wherein said pellets contain from 1 to 25% wt plant seed flour relative to total pellet weight excluding water and lipid.

9. The method as claimed in claim 1 or 2, wherein said pellets contain from 1 to 18% wt plant seed flour relative to total pellet weight excluding water.

10. The method as claimed in claim 1 or 2, wherein said pellets have a capacity to take up 1 to 2 L/kg water.

11. An aquaculture feed composition comprising protein-containing pellets, wherein said pellets comprise as a binder a plant seed flour, said pellets having a pellet solids density of at least 380 g/L.

12. An aquaculture feed composition comprising protein-containing pellets, wherein said pellets comprise as a binder a plant seed flour, the plant seed flour content being 1 to 25% wt lipid and water or 1 to 18% wt relative to a weight of the other pellet components other than water.

13. An aquaculture feed composition comprising protein-containing pellets, wherein said pellets comprise as a binder a plant seed flour, said pellets having a fresh water uptake capacity before disintegration of 0.8 to 7 L/kg.

14. (canceled)

15. The composition as claimed in claim 13, wherein said pellets have a fresh water uptake capacity before disintegration of 1 to 2 L/kg.

16. An aculture feed composition comprising protein-containing pellets, wherein said pellets comprise as a binder a plant seed flour, wherein said composition has two or more characteristics selected from the group consisting of:
(a) said pellets have a pellet solids density of at least 380 g/L;
(b) the plant seed flour content is 1 to 25% wt lipid and water;
(c) the plant seed flour content is 1 to 18% wt relative to a weight of the other pellet components other than water;
(d) said pellets having a fresh water uptake capacity before disintegration of 0.8 to 7 L/kg; and
(e) said pellets have a fresh water uptake capacity before disintegration of 1 to 2 L/kg.
